(19) United States
(12) Patent Application Publication
(10) Pub. No.: US 2020/0233930 A1
(43) Pub. Date: Jul. 23, 2020

(54) Construction Specification Generation

(71) Applicant: David Stutzman, Tuckahoe, NJ (US)

(72) Inventor: David Stutzman, Tuckahoe, NJ (US)

(21) Appl. No.: 16/253,069

(22) Filed: Jan. 21, 2019

(51) Int. Cl. G06F 17/50; G06F 16/18; G06F 17/24; G06F 17/22

(52) U.S. Cl. CPC G06F 17/5004; G06F 16/1873; G06F 3/0482; G06F 17/2288; G06F 17/248

(57) ABSTRACT

Systems and methods for generating a construction design such as a construction specification, wherein a processor generates a construction design by instantiating a construction design template, receiving user input to populate the construction design template, verifying user entries via compliance data and completing the construction design based on the template, user entry, and compliance data.

### TECHNICAL FIELD

The present disclosure is related generally to the construction industry and, more particularly, to systems and methods for facilitating specification generation for construction projects. Moreover, in various embodiments, multiple systems are combined to accomplish much more than construction specifications.

### BACKGROUND

In order for a construction project to be executed successfully, the project design must be fully and clearly communicated from the owner to the designer to the contractor and workers. An important part of that chain of communication is what is known as the “construction specification.” A construction specification may be part of the contract documents that accompany and control the construction of buildings and infrastructure projects.

Whether for residential, commercial, civil, or industrial builds, construction specifications describe the quality and performance of building materials, consistent with local codes and standards, as opposed to dictating material quantities and locations. While known standards such as MasterFormat® may provide names and numbers usable to reference materials, they do not provide an easy way to actually create construction specifications.

A construction specification may be categorized or subdivided by work types and intended results. These categories may be further subdivided into sections addressing, for example, material types or work products as they relate to the relevant category. For example, tile roofing and tile flooring may be specified in the construction specification in subdivisions of different categories. The ordering of specification divisions or categories may be based on their time of usage during the project.

The construction specification takes on additional importance if there is a discrepancy between the construction specification and the project drawings. Indeed, the construction specification can overrule the drawings in the event of discrepancies if the parties to the project contract so agree. Some public agencies actually require that the specifications overrule the drawings.

Construction specifications can be written to require certain performance results, or may be written to additionally describe how such performance is to be achieved, e.g., standards, techniques and so on. In addition, a construction specification may actually require the use of specific proprietary products, services or service providers. Further, a construction specification may be “closed” (i.e., listing necessary products), or “open” (i.e., allowing substitutions by the contractor). Finally, a construction specification may be a combination of the aforementioned formats.

Responsibility for the construction specification preparation typically falls to the architect, but the actual drafting is often outsourced to specialized construction specification writers. While these writers have generally become quite proficient at their task, there is still unavoidable waste and inefficiency in the task as it is currently executed, and there is a need for a tool that provides accurate and efficient specification preparation.

Before proceeding to the remainder of this disclosure, it should be appreciated that the disclosure may address at least a portion of the shortcomings listed or implicit in this Background section. However, any such benefit is not a limitation on the scope of the disclosed principles, nor of the attached claims, except to the extent expressly noted in the claims.

Additionally, the discussion of technology in this Background section is reflective of the inventors' own observations, considerations, and thoughts, and is not intended to be, to accurately catalog, or to comprehensively summarize any prior art reference or practice. As such, the inventors expressly disclaim this section as admitted or assumed prior art. Moreover, the identification or implication herein of one or more desirable courses of action reflects the inventors' own observations and ideas, and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objectives and advantages, may be best understood from the following detailed description taken in conjunction with the accompanying drawings of which:

FIG. 1 is a schematic representation of a computerized device within which various embodiments of the disclosed principles may be implemented;

FIG. 2 is a schematic drawing showing an operational environment of the construction specification tool in accordance with an embodiment of the disclosed principles;

FIG. 3 illustrates a process for construction specification generation in accordance with an embodiment of the disclosed principles;

FIG. 4 is an example screen shot showing a log in screen in accordance with an embodiment of the disclosed principles;

FIG. 5 is an example screen shot showing a first screen after logging in wherein users see their projects and the basic status of each project in accordance with an embodiment of the disclosed principles;

FIG. 6 is an example screen shot showing the first screen when creating a new project in accordance with an embodiment of the disclosed principles;

FIG. 7 is an example screen shot showing a project dashboard with the status and authors for each document included in the project in accordance with an embodiment of the disclosed principles;

FIG. 8 is an example screen shot showing a checklist to begin developing a project after creating a new project in accordance with an embodiment of the disclosed principles;

FIG. 9 is an example screen shot showing another checklist similar to the checklist of FIG. 7 in accordance with an embodiment of the disclosed principles but wherein the checklist is used with documents of a first format to make a link from one format to the other;

FIG. 10 is an example screen shot showing the location to collect many of the owner's project requirements and regulatory requirements affecting the project in accordance with an embodiment of the disclosed principles;

FIG. 11 is an example screen shot showing an Element B having a fairly complete description as well as the link connection to documents of another format for each of the component keyword phrases in accordance with an embodiment of the disclosed principles;

FIG. 12 is an example screen shot showing a Spec Section that illustrates the result of connecting one format to the other in accordance with an embodiment of the disclosed principles;

FIG. 13 is an example screen shot showing a default template for use in the event no master specification exists for a particular document in accordance with an embodiment of the disclosed principles; and

FIG. 14 is an example screen shot showing Properties and provides a way to show the status of each project document in accordance with an embodiment of the disclosed principles.

### DETAILED DESCRIPTION

Before discussing embodiments of the disclosed principles in full detail, an overview of certain embodiments is given to aid the reader in understanding the later more detailed discussion.

As noted above, construction specifications may be prepared by the project architect or, more frequently, by specialized construction specification writers. However proficient these writers may become, there is unavoidable waste and inefficiency inherent in the task as it is currently executed.

However, in an embodiment of the disclosed principles, a construction specification preparation tool is provided that yields accurate and efficient specification preparation. In an embodiment of the disclosed principles, the specification generation tool is executed on a computerized device to enable the accurate and efficient creation of a project construction specification.

Moreover, in various embodiments, multiple systems are combined to accomplish much more than construction specifications, being capable of capturing owner project requirements, performance requirements, design criteria, design decisions, system descriptions, construction specifications, and commissioning and operations requirements in addition to the material included in traditional construction specifications. The system in essence provides design management, akin to construction management.

The tool combines suitable construction specification conventions such as MasterFormat®, UniFormat™, and UNIFORMAT II or other construction specification conventions that provide numbers and titles, and cross-checks entered data to eliminate inconsistencies and discrepancies that might otherwise occur. The tool operates in one aspect by prepopulating known quantities, accessing and incorporating applicable rules and codes, and presenting available options for user selection.

With this overview in mind, and turning now to a more detailed discussion in conjunction with the attached figures, the techniques of the present disclosure are illustrated as being implemented in or via a suitable device environment. The following device description is based on embodiments and examples within which or via which the disclosed principles may be implemented, and should not be taken as limiting the claims with regard to alternative embodiments that are not explicitly described herein.

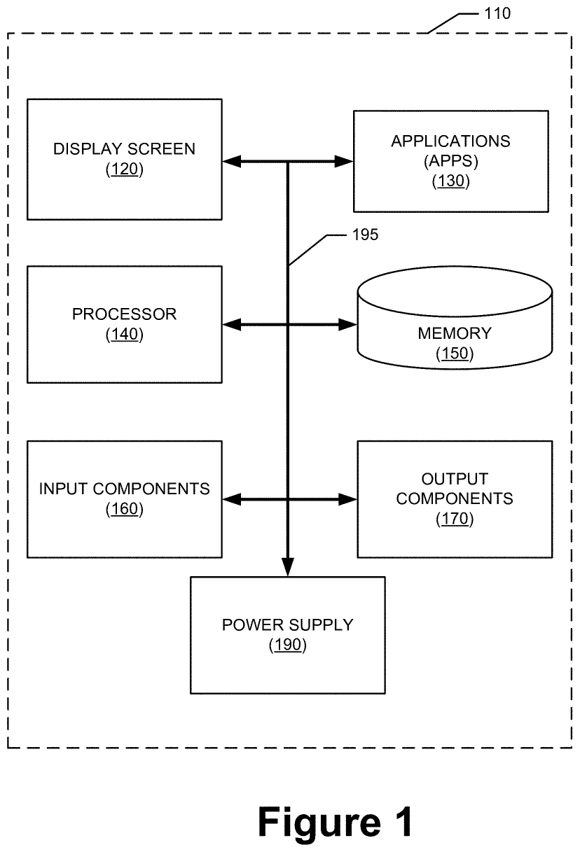

Thus, for example, while FIG. 1 illustrates an example computer environment with respect to which embodiments of the disclosed principles may be implemented, it will be appreciated that other device types may be used, including but not limited to servers, laptop computers, desktop computers, smartphones, workstation devices and other suitable devices. It will be appreciated that additional or alternative components may be used in a given implementation of the disclosed principles depending upon user preference, component availability, price point and other considerations.

In the illustrated embodiment, the components of the user device 110 include a display screen 120, applications (e.g., programs) 130, a processor 140, a memory 150, one or more input components 160 such as RF input facilities or wired input facilities, including, for example, one or more antennas and associated circuitry and logic. The antennas and associated circuitry may support any number of protocols, e.g., WiFi, Bluetooth, cellular, etc.

The device 110 as illustrated also includes one or more output components 170 such as RF (radio frequency) or wired output facilities. The RF output facilities may similarly support any number of protocols, e.g., WiFi, Bluetooth, cellular, etc., and may be the same as or overlapping with the associated input facilities. It will be appreciated that a single physical input may serve for both transmission and receipt.

The processor 140 can be a microprocessor, microcomputer, application-specific integrated circuit, or other suitable integrated circuit. For example, the processor 140 can be implemented via one or more microprocessors or controllers from any desired family or manufacturer. Similarly, the memory 150 is a nontransitory media that may (but need not) reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device or system). Additionally or alternatively, the memory 150 may include a read-only memory (i.e., a hard drive, flash memory or any other desired type of memory device).

The information that is stored by the memory 150 can include program code (e.g., applications 130) associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device 110. Such functions may include, for example, interaction among various internal components and storage and retrieval of applications and data to and from the memory 150.

Further with respect to the applications and modules, these typically utilize the operating system to provide more specific functionality, such as file system service and handling of protected and unprotected data stored in the memory 150. In an embodiment, modules are software agents that include or interact with hardware components such as one or more sensors, and that manage the device 110's operations and interactions with respect to the described embodiments.

With respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

In an embodiment, a power supply 190, such as a battery or fuel cell, is included for providing power to the device 110 and its components. Additionally or alternatively, the device 110 may be externally powered, e.g., by a wall socket, vehicle battery or other power source. In the illustrated example, all or some of the internal components communicate with one another by way of one or more shared or dedicated internal communication links 195, such as an internal bus.

In an embodiment, the device 110 is programmed such that the processor 140 and memory 150 interact with the other components of the device 110 to perform a variety of functions. The processor 140 may include or implement various modules and execute programs for initiating different activities such as launching an application, transferring data and toggling through various graphical user interface objects (e.g., toggling through various display icons that are linked to executable applications). As noted above, the device 110 may include one or more display screens 120. These may include one or both of an integrated display and an external display.

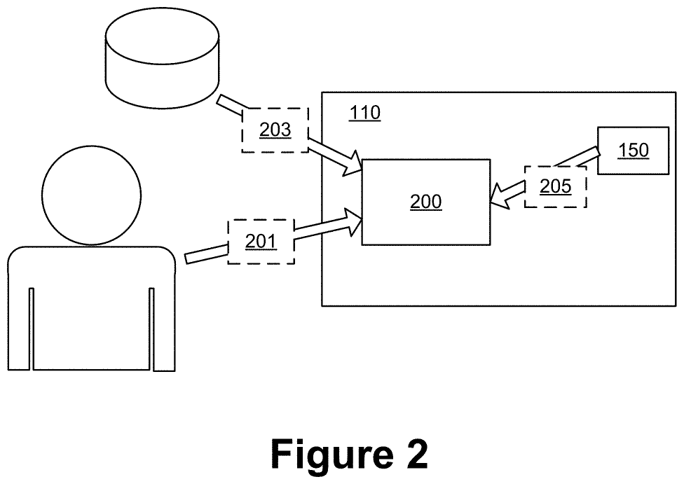

FIG. 2 is a schematic diagram showing the data flow within an embodiment of the described principles. As can be seen, the described tool 200, which may be a software module running on the user device 110, receives as input certain user-specified construction specification information 201, externally-sourced compliance information 203 (i.e., local or nonlocal codes and or rules that affect the construction specification), and internally-sourced construction specification format information 205.

The user-specified construction specification information 201 may comprise project-specific values such as certain construction materials, performance results, operational requirements, construction methods, construction standards, specific proprietary products, services or service providers. This information may be received by the user device 110, and hence the construction specification tool 200, via one or more user-input facilities (160) of the device 110, e.g., a device keyboard.

The externally-sourced compliance information 203 may comprise codes, rules or ordinances that control requirements of the project (e.g., number of exits), the usage of one or more materials (e.g., fire brick) or techniques (e.g., concrete laying or curing techniques). Again, this information may be received by the user device 110, and hence the construction specification tool 200, via one or more user-input facilities (160) of the device 110, and more particularly, a hard-wired or wireless connection to a source of such information.

Finally, the construction specification format information 205 may be internally-stored and/or internally-generated formatting information that specifies a format of the construction specification, e.g., by specifying categories or classes, subcategories or subclasses, and so on. As noted above, there are several available formats with which one may wish to comply, and the user may wish to use some, all, or none of such publicly available formats, or may mix portions of different formats to achieve an ideal balance.

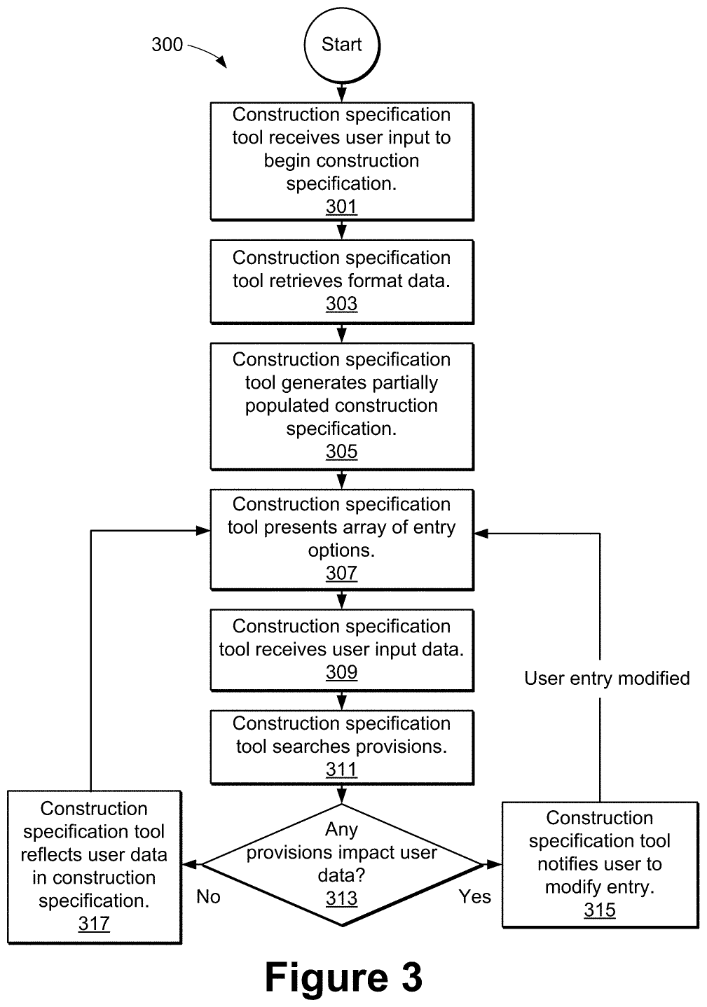

Turning to FIG. 3, this figure shows an exemplary process 300 for the generation of a construction specification in accordance with an embodiment of the described principles. It will be appreciated that the process 300 may be implemented via computer-executable instructions, e.g., program code, stored on, and read from, a computer-readable medium, e.g., a hard drive memory, optical drive memory or solid state memory of the user device 110. Thus, these steps reflect not only an exemplary process but also the computer-readable instructions necessary to implement the exemplary process.

At stage 301 of the process 300, a construction specification tool (e.g., FIG. 2 element 200) receives user input to begin a construction specification. The construction specification tool then retrieves format data at stage 303, and generates a partially populated construction specification in keeping with the retrieved format data at stage 305.

The construction specification tool then presents an array of entry options to the user of the device at stage 307. The entry options may include, for example, options to specify a task, material, technique and so on. At stage 309 of the process 300, the construction specification tool receives user input data related to at least one of the displayed entry options, e.g., a user selection or specification of a task, material or technique.

The construction specification tool then searches rules, laws and ordinances at stage 311 to identify provisions that may be applicable to the received user input data. The searched data may be external, i.e., an external memory or server, or internal, i.e., the device's own memory (e.g., memory 150, FIG. 1). At stage 313, the construction specification tool determines whether any identified provision impacts the entered user data. If it is determined at stage 313 that an identified provision does impact the entered user data, then the process 300 flows to stage 315, wherein the construction specification tool notifies the user to modify the entry. Otherwise, the process 300 continues to stage 317 from stage 313, wherein the user data is reflected in the construction specification. At this point, the process 300 may return to stage 307 to continue guiding the user through the creation of the construction specification.

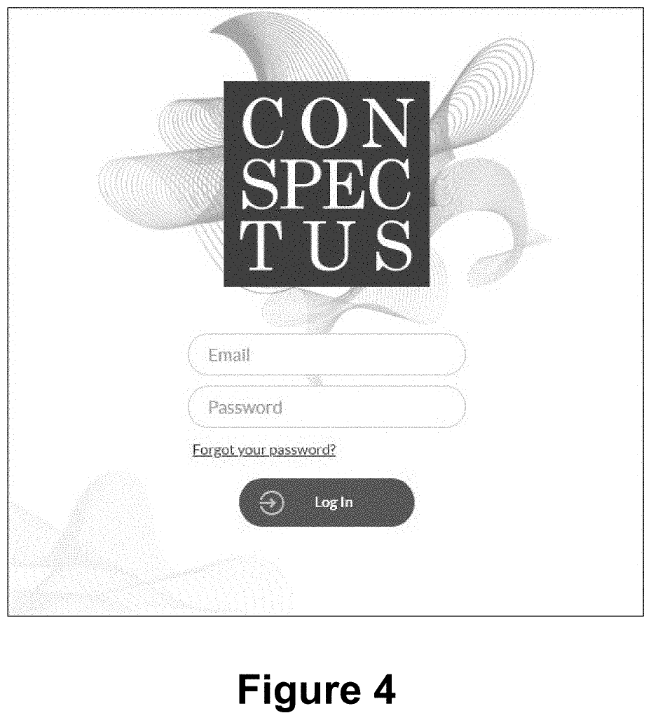

Having discussed the hardware and operations of the construction specification tool, FIGS. 4-14 provide examples of the creation and manipulation of a sample document using the tool.

FIG. 4 is the log in screen where the system is accessed after creating an account by being invited to participate in the first project. Once an account is created, users can access all projects for which they have permissions after logging in.

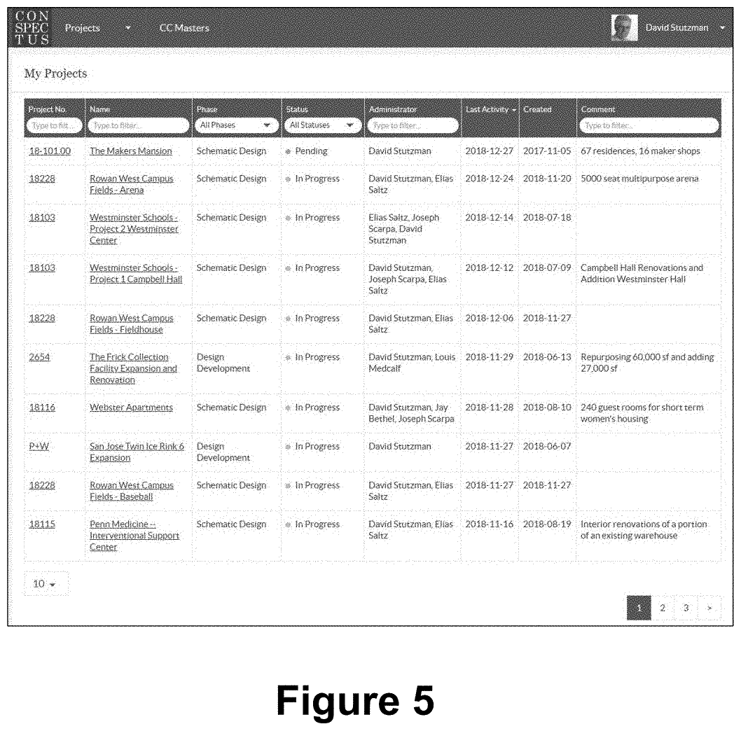

FIG. 5 is the first screen after logging in where users see their projects and the basic status of each project, including the last activity.

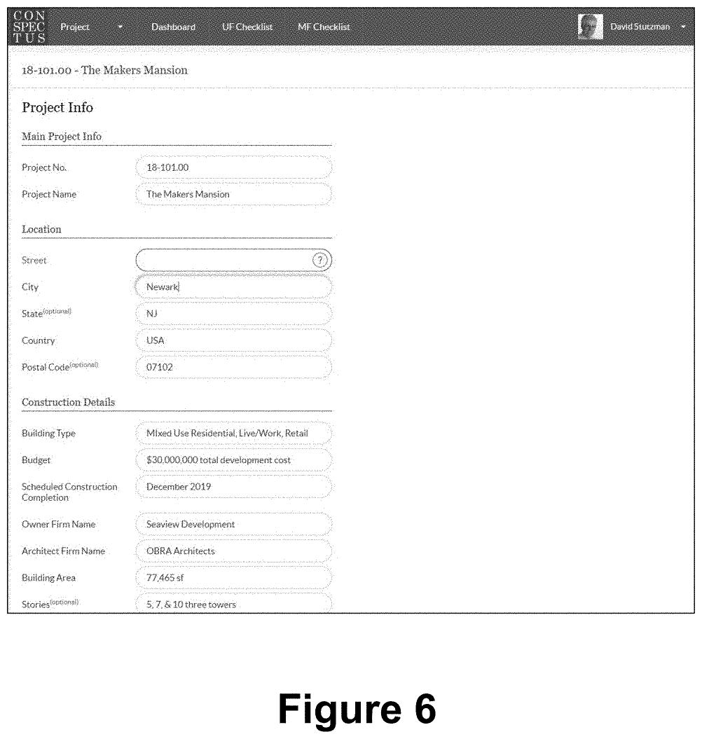

FIG. 6 is the first screen when creating a new project. You can see the street field is red, meaning the field must be completed before the project can be created. The system monitors each non-optional field in this window to ensure all are completed to begin a new project.

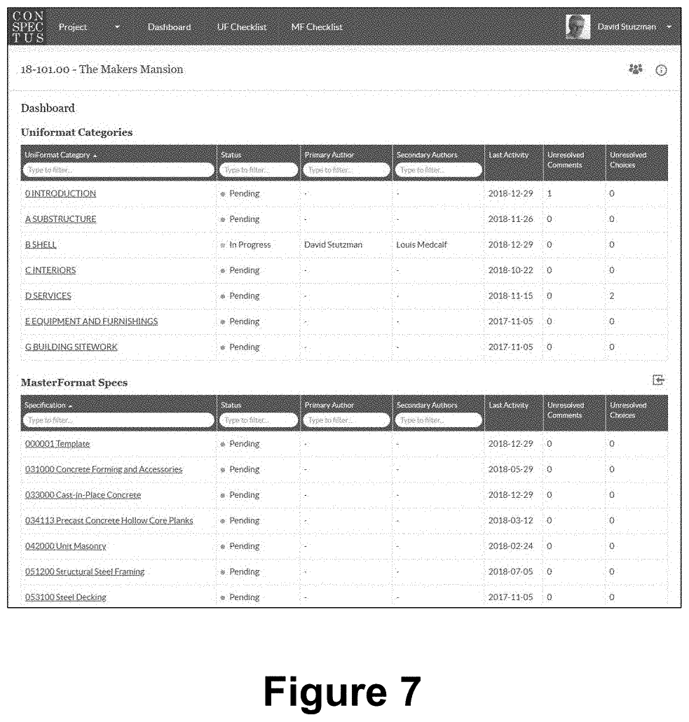

FIG. 7 shows project dashboard showing the status and authors for each document included in the project. Most importantly it provides a snapshot view of the number of unresolved comments and specifications choices in each document. This lets users sort and filter to find documents that are incomplete and those with the most unresolved issues.

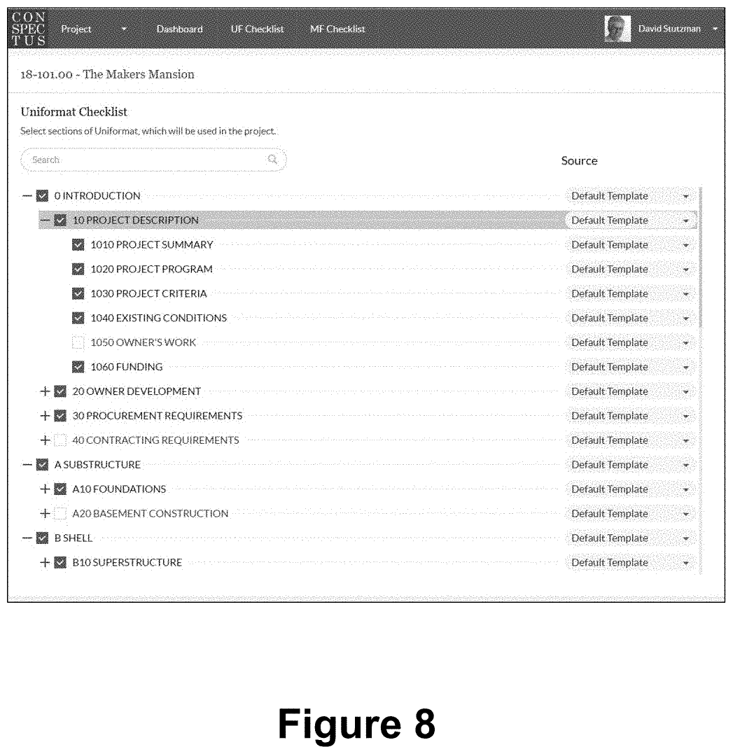

FIG. 8 shows a checklist to begin developing a project after creating a new project. Here each of the major elements is selected to be added to the project. Additionally the appropriate default, master, or project template to apply to the project can be selected for each document.

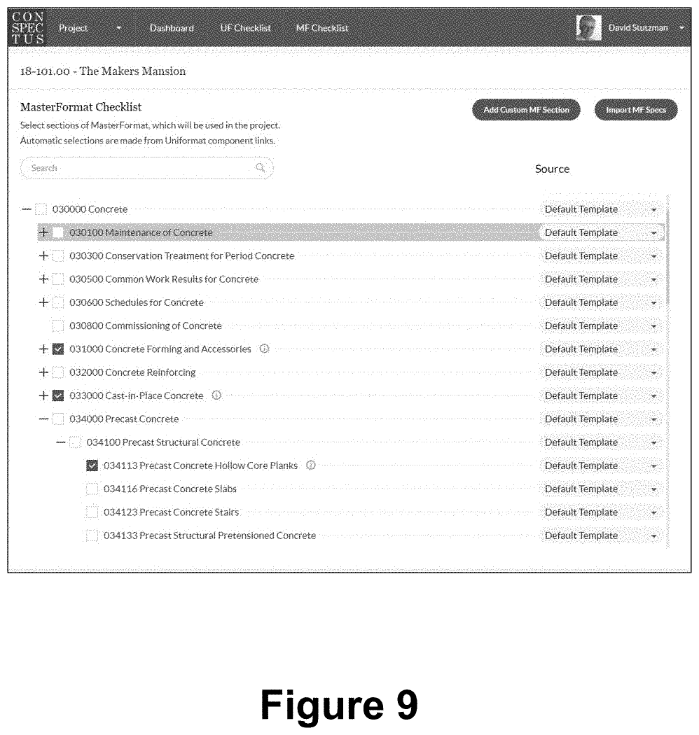

FIG. 9 shows another checklist similar to the checklist of FIG. 7 but wherein the checklist is used with documents of a first format to make a link from one format to the other.

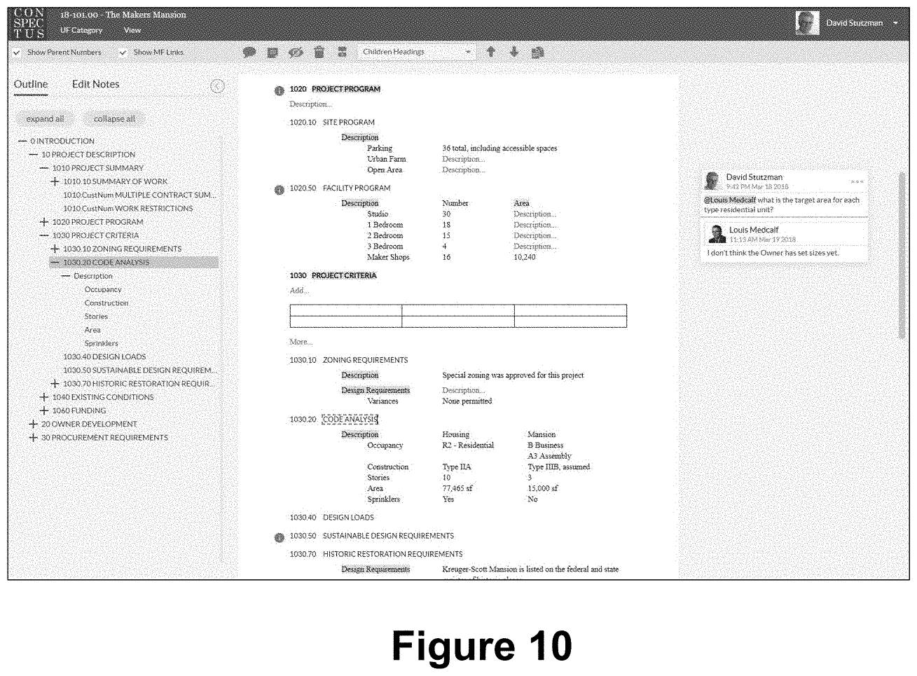

FIG. 10 shows the location to collect most of the owner's project requirements and regulatory requirements affecting the project. In an embodiment, code data entries are used to help make high level specification edits. You can also see the threaded commenting feature where questions can be asked, answered and resolved. These comments are tracked on the project dashboard until they are marked as resolved.

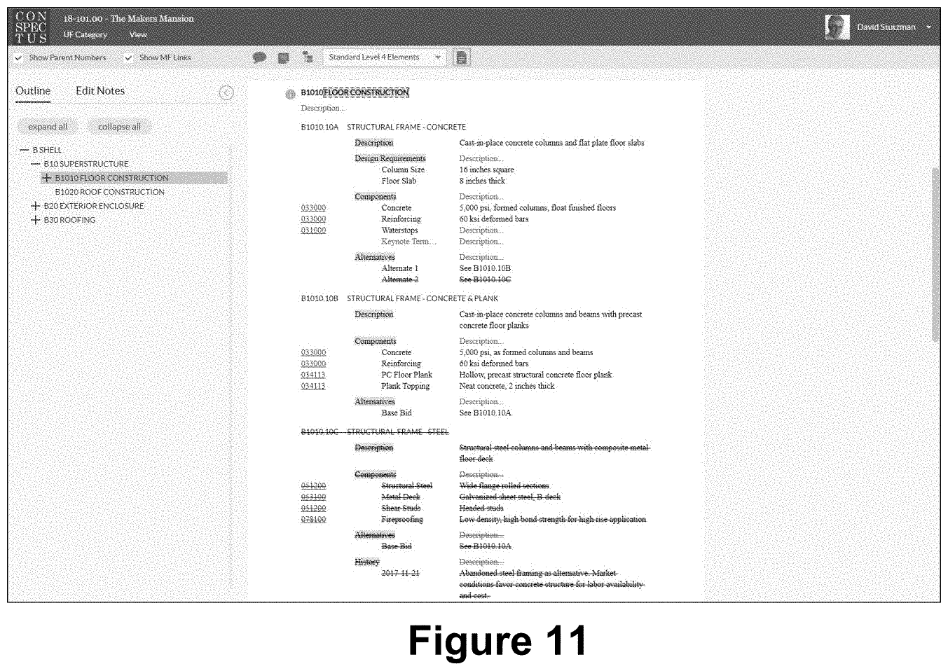

FIG. 11 shows an Element B having a fairly complete description as well as the link connection to documents of another format for each of the component keyword phrases.

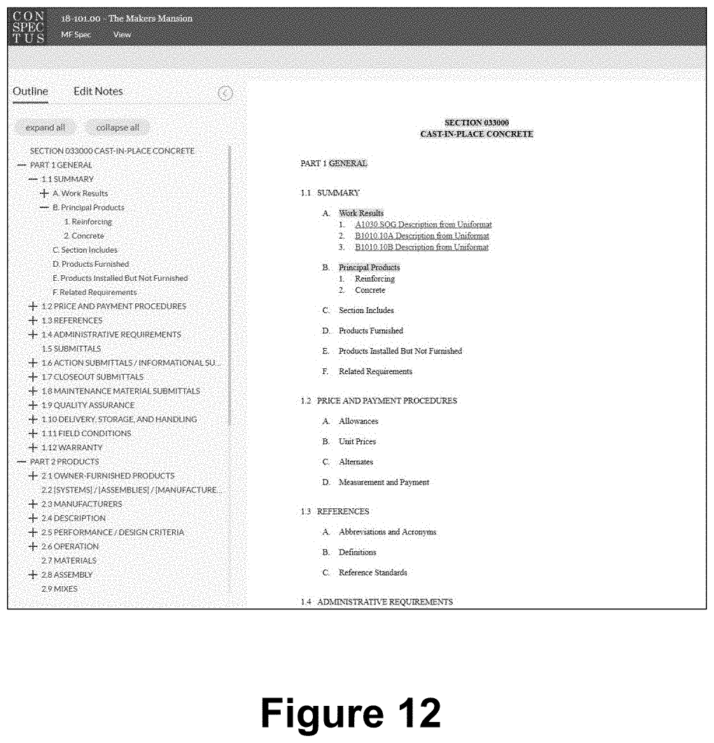

FIG. 12 shows a Spec Section that illustrates the result of connecting one format to the other. The work results and principal products are automatically populated with text directly from Uniformat (i.e., parts of either or both Uniformat and UNIFORMAT II). Because this is a draft view, the links are shown instead of the actual text that will be displayed in the final view.

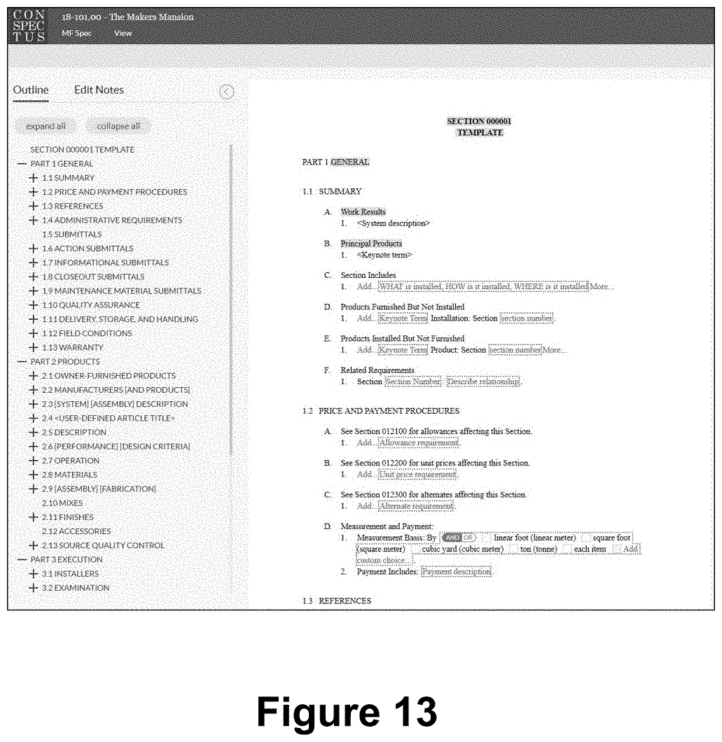

FIG. 13 shows a template that will serve as the default template if no master specification exists for a particular document. The template shows instructional text objects as fill-in-the-blanks and a choice group where the specifier can make choices with checkboxes to complete the specification. When all the choices are resolved, the dashed pink outlines are shown in solid blue and the project dashboard will show zero unresolved choices.

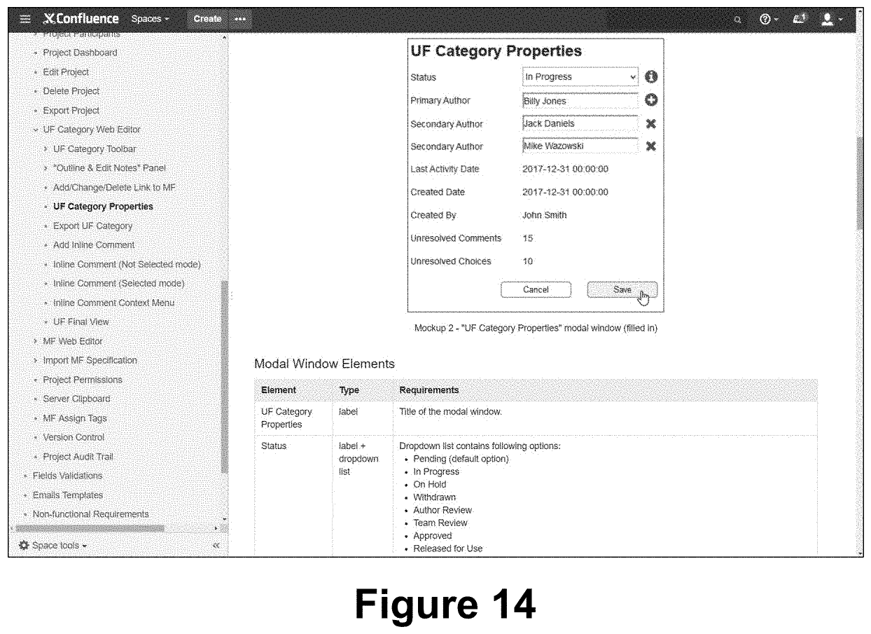

FIG. 14 shows Properties and provides a way to show the status of each project document. The available status options are shown below the sample window. The system will check the unresolved items before allowing the document to be marked “Released for Use.” If any items remain unresolved, the system will not permit the document to be released for use. Documents of either format work the same way in this regard.

In a further embodiment, the construction design generation tool provides version control, wherein users can define versions of each document. Moreover, the tool may further track document events for user-initiated reversion or review. For example, a user may wish to compare the current version to a past version.

The tracked document events may include, for example, events executed via a document menu. These may be such events as version creation, adding a document, creating a new document, importing a document, addressing comments in the document, and addressing edits in the document.

It will be appreciated that various systems and processes have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A construction design generation tool comprising:
a local non-transitory memory medium;
a network connection configured to selectively access a network for access to resources on the network; and
a processor configured to generate a construction design document by instantiating a construction design template based on data retrieved from the local non-transitory memory medium, receiving user input to populate the construction design template, verifying user entries via compliance data retrieved via the network connection and completing the construction design based on the template, user entry, and compliance data, wherein the construction design includes data arranged in accordance with a plurality of construction specification formats.

2. The construction design generation tool in accordance with claim 1, wherein the construction design is a construction specification.

3. The construction design generation tool in accordance with claim 1, wherein the plurality of construction specification formats include two or more of MasterFormat®, UniFormat™, and UNIFORMAT II.

4. The construction design generation tool in accordance with claim 1, wherein the tool further provides version control wherein users can define versions of each document.

5. The construction design generation tool in accordance with claim 4, wherein the tool further tracks document events for user-initiated reversion or review.

6. The construction design generation tool in accordance with claim 5, wherein the tracked document events comprise events executed via a document menu.

7. The construction design generation tool in accordance with claim 6, wherein the tracked document events include version creation, adding a document, creating a new document, importing a document, addressing comments in the document and addressing edits in the document.

8. A non-transitory memory medium having stored thereon computer-executable instructions for construction design generation, the instructions including instructions for:
instantiating a construction design template based on data retrieved from the local non-transitory memory medium;
receiving user input to populate the construction design template;
verifying user entries via compliance data retrieved via the network connection; and
completing the construction design based on the template, user entry, and compliance data, wherein the construction design includes data arranged in accordance with a plurality of construction specification formats.

9. The non-transitory memory medium in accordance with claim 8, wherein the construction design is a construction specification.

10. The non-transitory memory medium in accordance with claim 8, wherein the plurality of construction specification formats include two or more of MasterFormat®, UniFormat™, and UNIFORMAT II.

11. The non-transitory memory medium in accordance with claim 8, further including instructions for version control wherein users can define versions of each document.

12. The non-transitory memory medium in accordance with claim 11, further including instructions for tracking document events for user-initiated reversion or review.

13. The non-transitory memory medium in accordance with claim 12, wherein the tracked document events comprise events executed via a document menu.

14. The non-transitory memory medium in accordance with claim 13, wherein the tracked document events include version creation, adding a document, creating a new document, importing a document, addressing comments in the document and addressing edits in the document.
